(19) United States
(12) Patent Application Publication
(10) Pub. No.: US 2024/0126605 A1
(43) Pub. Date: Apr. 18, 2024

(54) GUIDED WORKLOAD PLACEMENT REINFORCEMENT LEARNING EXPERIENCE PRUNING USING RESTRICTED BOLTZMANN MACHINES

(71) Applicant: Dell Products L.P., Round Rock, TX (US)

(72) Inventors: Yanexis Pupo Toledo, Niteroi (BR); Micael Veríssimo de Araújo, Rio de Janeiro (BR); Eduardo Vera Sousa, Niteroi (BR)

(21) Appl. No.: 18/047,459

(22) Filed: Oct. 18, 2022

(51) Int. Cl. G06F 9/50; G06N 20/00

(52) U.S. Cl. CPC G06F 9/5027; G06N 20/00

(57) ABSTRACT

One example method includes defining experiences for a workload that are to be analyzed at a first machine-learning (ML) model. The experiences define an association between the workload and microservices having computing resources that execute the workload. A probability of using each of the microservices of the experiences to execute the workload is generated at a second ML mode. A determination is made of which of the experiences have a probability that indicates that the experience will generate a low reward when analyzed by the first ML model. The experiences that generate the low reward are removed from the experiences to be analyzed at the first ML model. The experiences that have not been removed are analyzed at the first ML model to determine which experience includes microservices that should be used to execute the workload.

### FIELD OF THE INVENTION

Embodiments of the present invention generally relate to placing workloads in a computing environment. More particularly, at least some embodiments of the invention relate to systems, hardware, software, computer-readable media, and methods for using infrastructure efficiently to execute workloads while respecting service level agreements (SLAs) and ensuring quality of service (QoS).

### BACKGROUND

Cloud computing has several advantages, which include pay-per-use computation from the customer's perspective and resource sharing from the provider's perspective. Using virtualization, it is possible to abstract a pool of computing devices to offer computing resources to users (e.g., consumers or customers) that are tailored to the needs of the users. Using various abstractions such as containers and virtual machines, it is possible to offer computation services without the user knowing what infrastructure is executing the user's code. These services may include Platform as a Service (PaaS) and Function as a Service (FaaS) paradigms.

In these paradigms, the QoS expected by the user may be expressed through SLAs. SLAs often reflect expectations such as response time, execution time, uptime percentage, and/or other metrics. Providers try to ensure that they comply with the SLAs in order to avoid contractual fines and to preserve their reputation as an infrastructure provider.

Providers are faced with the problem of ensuring that they comply with the contractual agreements (e.g., SLAs) to which they have agreed. Providers may take different approaches to ensure they comply with their contractual agreements. In one example, a provider may dedicate a static number of resources to each user. This presents a couple of problems. First, it is problematic to assume that an application is bounded by one particular resource. Some applications may have an IO (Input/Output) intensive phase followed by a compute-intensive phase. Dedicating some number of static resources to each user may result in inefficiencies and idle resources. Further, it is possible that the initial allocation of resources may be under-estimated or over-estimated.

Allocating excessive resources may also adversely impact the provider. From the perspective of a single workload, the provider may perform the workload and easily comply with the relevant SLAs. However, the number of users that can be served by the provider is effectively reduced because the number of spare resources dictates how many workloads can be performed in parallel while still respecting the SLAs. As a result, allocating excessive resources to a single workload impacts the overall efficiency and may limit the number of workloads the provider can accommodate.

While SLAs are often determined in advance of performing a workload, the execution environment is more dynamic. New workloads may compete for computing resources, and this may lead to unplanned demand, which may disrupt the original workload planning because of a greater need to share resources, workload priorities, and overhead associated with context switching.

The challenge facing providers is to provide services to their users in a manner that respects SLAs while minimizing resource usage. Stated differently, providers are faced with the challenge of efficiently using their resources to maximize the number of users.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a reinforcement learning (RL) model;

FIG. 2 discloses aspects of a Restricted Boltzman Machine (RBM) model;

FIG. 3 illustrates an example embodiment of a computing system that is configured to prune or remove one or more experiences prior to performing reinforcement learning;

FIGS. 4A-4D illustrate a use case using the computing system of FIG. 3;

FIG. 5 illustrates an example method for one or more machine-learning models to remove experiences that will generate low rewards in an RL model;

FIG. 6 illustrates an example computing system in which the embodiments described herein may be employed.

### DETAILED DESCRIPTION OF SOME EXAMPLE EMBODIMENTS

Embodiments of the present invention generally relate to workload placement and resource allocation. More particularly, at least some embodiments of the invention relate to systems, hardware, software, computer-readable media, and methods for allocating resources using multi-agent reinforcement learning-based systems or pipelines. Example embodiments of the invention further relate to executing workloads while respecting service level agreements (SLAs) and ensuring quality of service (QoS).

SLAs are typically set or determined before a workload is executed. However, the execution of the workload is subject to various issues that may impact the ability of the provider to meet the requirements of the SLAs. Examples of such issues include inadequate knowledge about actual resource requirements, unexpected demand peaks, hardware malfunctions, or the like.

Workloads often have different bottlenecks. Some workloads may be compute-intensive while other workloads may be IO (Input/Output) intensive. Some workloads may have different resource requirements at different points of their executions. As a result, some workloads can be executed more efficiently in certain resource environments and it may be beneficial, at times, to migrate a workload to a new environment. For example, the execution environment during a compute-intensive phase of the workload may be inadequate for an IO intensive phase of the same workload.

Embodiments of the invention relate to allocating resources as required or, more specifically, to placing and/or migrating workloads in order to comply with SLAs and to efficiently use resources. In one example, allocating resources is achieved by placing workloads in specific resources, which may include migrating the workloads from one location to another workload. Workloads are placed or migrated such that SLAs are respected, to cure SLA violations, and/or such that the resources of the provider are used beneficially from the provider's perspective. One advantage of embodiments of the invention is to allow a provider to maximize use of their resources.

Embodiments also relate to pruning or removing experiences defining workload-microservice associations. In one example, a probability of using a microservice to execute the workload is determined. Based on this determination, those experiences that are likely to generate a low reward when using machine-learning models to model the resource and workload allocation are removed from being modeled. This advantageously saves on time and computing resource overhead while allowing the machine-learning model to converge more quickly.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

Aspects of a Reinforcement Learning Model

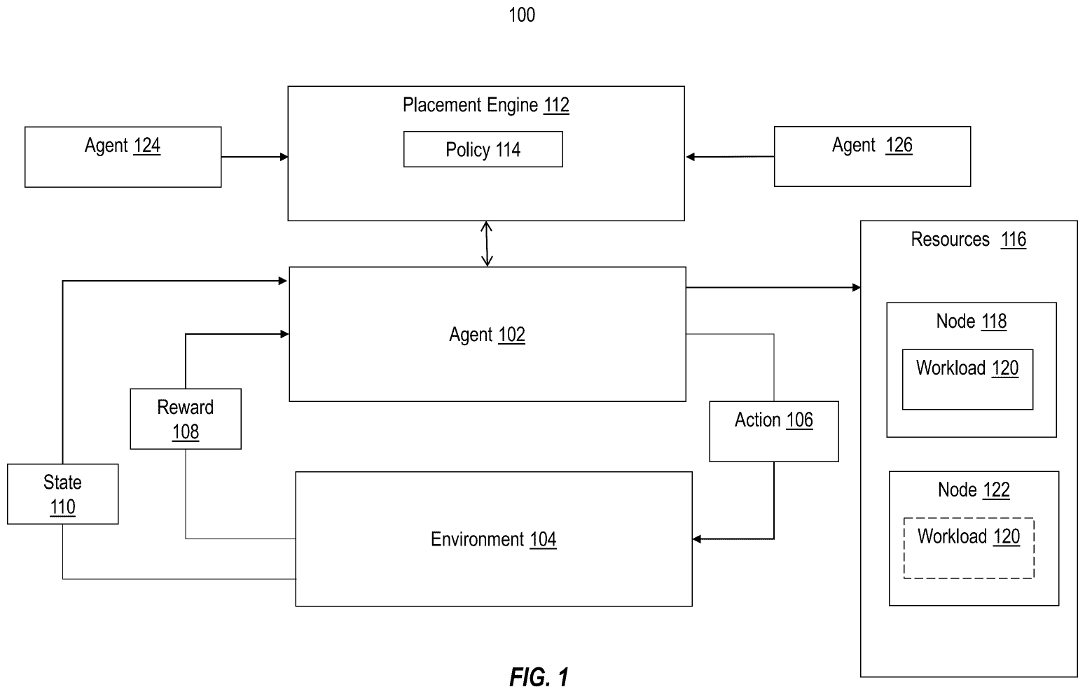

FIG. 1 discloses an embodiment 100 of using a Reinforcement Learning (RL) model to allocate resources to workloads. Further detail about using a reinforcement learning model to allocate resources to workloads is disclosed in U.S. patent application Ser. No. 17/811,693 entitled SWARM MULTI-AGENT REINFORCEMENT LEARNING-BASED PIPELINE FOR WORKLOAD PLACEMENT and filed Jul. 11, 2022, which is incorporated herein by reference in its entirety.

In FIG. 1, an agent 102 may be associated with a workload 120 being executed at a node 118, implemented as a virtual machine, which may be part of computing resources 116 available to be used by the RL model. The computing resources 116 may include computing devices or systems with processors, GPUs, CPUs, memory, network hardware, and the like and may include physical machines, virtual machines, containers, and the like that are configured to execute or otherwise perform the workload 120. The agent 102 may perform an action 106 (e.g., a placement action) with regard to the workload 120. The action 106 may include leaving the workload 120 at the node 118 or moving/migrating the workload 120 to the node 122 as illustrated by the dashed lines for the workload 120 in the node 122.

The action 106 is thus executed in the environment 104, which includes the computing resources 116 or more specifically nodes 118 and 122, which may implement virtual machines, physical machines, and/or other computing infrastructure that is used to execute or otherwise perform the workload 120. After execution or during execution of the workload 120, the state 110 and/or a reward 108 may be determined and returned to the agent 102 and/or to the placement engine 112.

In one example embodiment, the reward 108 may be a value that represents the execution of the workload 120 relative to an SLA or an SLA metric. For example, the reward may represent a relationship between the response time or system latency of the workload and the response time or system latency specified in the SLA.

The state 110 of the environment 104 and the reward 108 are input into a placement engine 112, directly or by the agent 102 as illustrated in FIG. 1. The state 110 may include the state of each virtual machine included in the resources 116. This information can be represented in a one hot encoding style. In this example, the reward 108 reflects the actual performance at the virtual machine of the node 118 of the workload 120. If using response time as a metric, the reward reflects the relationship between the actual response time and the SLA response time.

The placement engine 112 may generate a new recommended action for the agent 102 to perform for the workload 120. This allows the agent 102 to continually adapt to changes (e.g., SLA compliance/non-compliance) at the computing resources 116 and perform placement actions that are best for the workload 120 and/or for the provider to comply with SLA requirements, efficiently use the resources 116, or the like.

The placement engine 112 may also have a policy 114 that may impact the placement recommendations. The policy, for example, may be to place workloads using a minimum number of virtual machines, to perform load balancing across all virtual machines, or to place workloads using reinforced learning. These policies can be modified or combined. For example, the policy may be to place workloads using reinforced learning with some emphasis towards using a minimum number of virtual machines or with emphasis toward load balancing. Other policies may be implemented.

The output of the placement engine 112, may depend on how many actions are available or defined. If a first action is to keep the workload where the workload is currently operating and the second action is to move the workload to a different node, the output of the placement engine may include two anticipated rewards. One of the rewards corresponds to performing the first action and the other reward corresponds to performing the second action. The action selected by the agent 102 will likely be the action that is expected to give the highest reward. As illustrated in FIG. 1, multiple agents 124, 126, and 102 may use the same placement engine 112. In one example, because the computing resources 116 may include multiple virtual machines, an expected reward may be generated for migrating the workload to one of those virtual machines that is geographically closest to the workload 120 so as minimize system response time.

The placement engine 112, prior to use, may be trained. When training the placement engine 112, workloads may be moved randomly within the resources 116. At each node, a reward as generated. These rewards, along with the state, can be used to train the placement engine 112. Over time, the placement becomes less random and begins to rely on the output of the placement engine 112 until training is complete.

Thus, the placement engine 112, by receiving the reward 108 and state 110 during training, which may include multiple migrations of the workload to the nodes of the resources 116, some of which may be random, can implement reinforcement learning. Embodiments of the invention, however, may provide deep learning reinforcement learning. More specifically, the placement engine 112 may include a neural network that implements RL models to allow one or more experiences of the agents, along with random migrations to different resource allocations for performing the workload 120, to train the placement engine 112.

In other words, during the training process for the placement engine 112, the agents 102, 124, 126 take an action by placing the workload 120 into a different node in the computing resources 116 such as the nodes 118 and 122 that include associated computing resources such as virtual machines, processors, and the like as discussed above that can execute the workload 120. Each of the placements of the workload 120 into a different node for execution is considered an “experience” and analysis of the placement actions and the corresponding rewards are used to train the placement engine 112. The experiences may be chosen randomly so that all (or at least a significant portion) of the different combinations of workload-node associations can be analyzed to find the best workload-node association that is geographically closest to the workload 120 so as minimize system response time.

As will be appreciated, it may take a large number of experiences to train the placement engine 112 due to the numerous different combinations of workload-node associations. Many of the experiences will generate a low reward in the RL model and thus in operation the workload 120 will never be placed in a node having the computing resources 116 that cause the low reward. In contrast, many experiences will generate a high reward and in operation could be considered for having the workload 120 executed at the node having the computing resources 116 that cause the high reward. For example, if in a first experience the workload 120 is placed at a node that implements a virtual machine and other computing resources 116 that are a long distance from the where the workload 120 is located, the response time or system latency may be higher than the SLA constraints and so a low reward would be generated. However, if in a second and third experience the workload 120 is placed at nodes that implement a virtual machine and other computing resources 116 that are a close distance from the where the workload 120 is located (or at least closer than the virtual machine and other computing resources of the first experience), the response time or system latency may be within the SLA constraints and so a high reward would be generated for both the second and third experiences.

In the above example, it would save time and computing resource overhead if the RL models of the placement engine 112 did not have to analyze the first experience during training since in operation the workload 120 will never be placed in a node having the computing resources 116 that cause the low reward. Rather, if the analysis could be focused on determining which of the nodes of the second and third experiences would provide better response time since both of these nodes are candidates for actual placement, the RL models of the placement engine 112 would converge more quickly to the best placement for the workload 120.

Advantageously, the principles disclosed herein provide a mechanism for removing or pruning at least some of the experiences that would generate a low reward before they are input into the RL models. In this way, the training of the RL models is focused primarily on those experiences that would generate a high reward, thus saving on time and computing resource overhead and allowing the RL models to converge more quickly. Specifically, the principles disclosed herein provide for a learning model, that in one embodiment implements a Restricted Boltzman Machine (RBM), to remove the experiences that would generate a low reward as will be explained in further detail to follow.

Aspects of a Restricted Boltzman Machine (RBM) Model

A Boltzmann Machine (BM) is a non-supervised learning method able to model the probability of achieving a state in a Markovian Process, such as in reinforcement learning models. Thus, a BM can be used in RL models to provide a O-function approximator in a Deep O-learning method in reinforcement learning. A Restricted Boltzmann Machine (RBM) is a ramification from the original BM where the connections between nodes in the same layer are removed, which makes the probability obtained by theses nodes independent from each other and the only dependence comes from their inputs. Notice that since RBMs are a non-supervised learning model, the training does not rely on dataset annotation, making it very similar to an auto-encoder training, with the difference that RBMs can encode the probability of transitions between states in a Markovian Process.

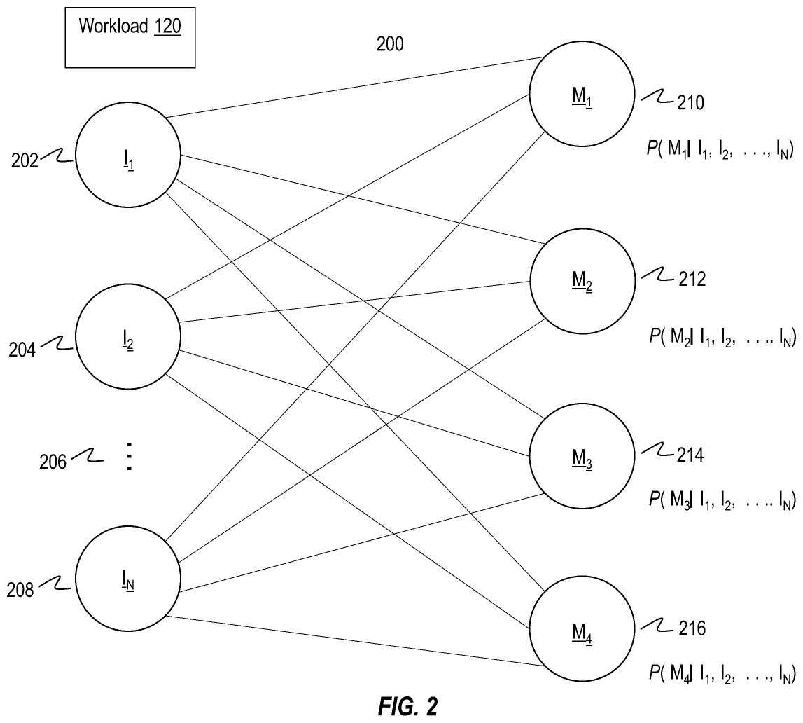

FIG. 2 illustrates the an example embodiment 200 of an RBM that uses an architecture where each node of the visible layer represents features of the workload 120 as inputs. As shown in FIG. 2, the embodiment 200 includes an input I₁ shown at 202, an input I₂ shown at 204, and an input I_{N} shown at 208. The features as inputs represent information about the workload, for example the data type of the workload, the computing resources 116 such as GPUs or CPUs needed to execute the workload 120, the geographical location of the workload 120, the usage or execution patterns of the workload 120, and any other relevant information needed to determine the best microservice to use to execute the workload 120 while reducing response time or system latency. It will be appreciated that the ellipses 206 in FIG. 2 represent that there can be any number of features as inputs and so the embodiments and claims disclosed herein are not limited to the number or type of features used as inputs.

The architecture of the embodiment of 200 uses each node of the hidden layer to represent a microservice that can be allocated to execute or perform the workload 120. As shown in FIG. 2, the embodiment 200 includes a microservice M₁ shown at 210, a microservice M₂ shown at 212, a microservice M₃ shown at 214, and a microservice M₄ shown at 216. Each microservice represents a set of computing resources 116 such as virtual machines, physical machines, GPU, and/or CPU that can be implemented at one or more locations that have the capability to execute the workload 120. Thus, each microservice may implement a different set of the computing resources 116 as its computing infrastructure.

Accordingly, the computing infrastructure and the distance between the workload 120 and the microservice will determine the response time or system latency for the microservice to execute or perform the workload 120. That is, some microservices may have a computing infrastructure that would execute the workload 120 faster than the computing infrastructure of a different microservice. In addition, some microservices may be closer to the workload 120 than other microservices.

In operation, the RBM uses the inputs I₁, I₂, and I_{N} to estimate a probability P of using each of the microservices M₁, M₂, M₃, and M₄ for executing the workload 120 given the computing resources associated with each of the microservices. In the embodiment, the probability P (M₁|I₁, I₂, . . . , I_{N}) is the probability of using the microservice M₁ given the inputs I₁, I₂, and I_{N}, the probability P (M₂|I₁, I₂, . . . , I_{N}) is the probability of using the microservice M₂ given the inputs I₁, I₂, and I_{N}, the probability P (M₃|I₁, I₂, . . . , I_{N}) is the probability of using the microservice M₃ given the inputs I₁, I₂, and I_{N}, and the probability P (M₄|I₁, I₂, . . . , I_{N}) is the probability of using the microservice M₄ given the inputs I₁, I₂, and I_{N}. If the probabilities returned by the hidden layer of the RBM are P(M₁)>P(M₂)>P(M₃)>P(M₄), this means that it much more likely that the microservice M₁ will be used to execute the workload 120 than the other microservices given the network latency and microservice placement aspects of the network. This information can be used to help remove or prune experiences as will be explained in more detail to follow.

Aspects of Experience Pruning or Removing

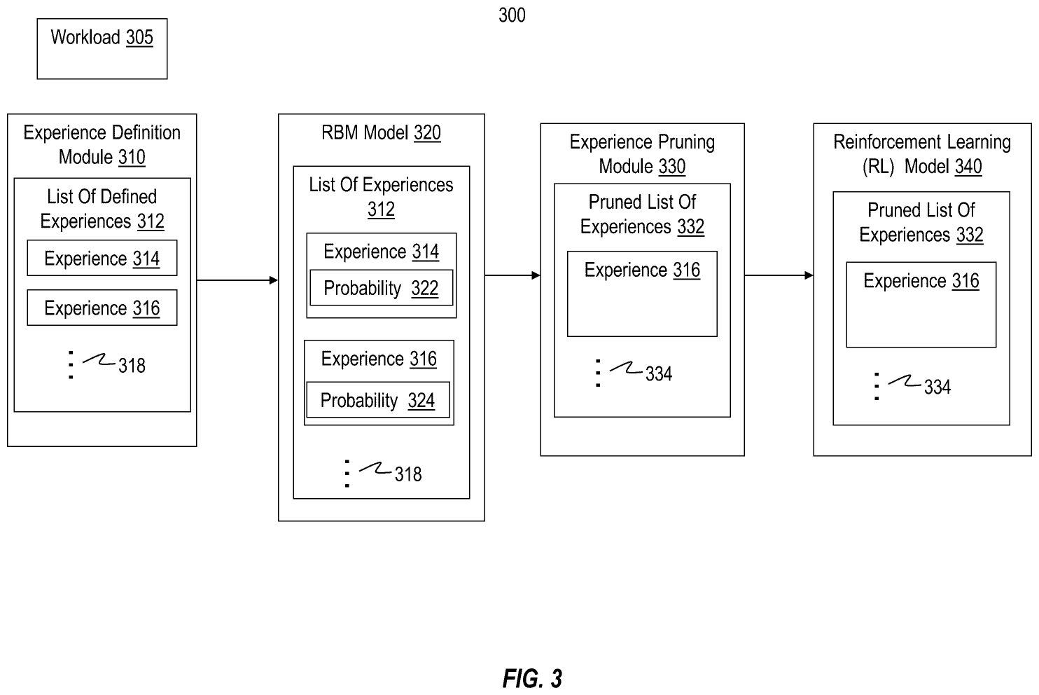

FIG. 3 illustrates an example embodiment of a computing system 300 that is configured to prune or remove one or more experiences prior to performing reinforcement learning. As illustrated, the computing system 300 includes an experience definition module 310. In operation, the experience definition module 310 is configured to define one or more experiences that will be placed into a RL model for determining workload placement and resource allocation. As mentioned previously, each placement of a workload into a different microservice for execution is considered an “experience”. The experiences may be chosen randomly so that all (or at least a significant portion) of the different combinations of workload-microservice associations can be analyzed to find the best workload-microservice association that is geographically closest to the placement of the workload so as minimize system response time. As shown, the experience definition module 310 generates a list of the possible defined experiences 312 for a workload 305, which may correspond to the workload 120, that includes an experience 314, an experience 316, and any number of additional experiences as illustrated by the ellipses 318.

The list of defined experiences 312 is received by a machine-learning model 320, which in the embodiment may be a RBM machine-learning model corresponding to the RBM model discussed in relation to FIG. 2. The features of the workload 305 are used as inputs to each of the microservices defined in the experiences 314, 316, and 318. For each microservice, a probability is determined in the manner discussed in relation to FIG. 2. Thus, a probability 322 is determined for the microservice defined in the experience 314, a probability 324 is determined for the microservice defined in the experience 316, and non-illustrated probabilities are determined for the microservices defined in the experiences 318.

The list of defined experiences and the determined probabilities are then received by an experience pruning or removal module 330. In operation, the experience pruning module 330 is configured to use the probabilities to determine experiences that are likely to generate a low reward in the RL model and so need not be analyzed by the RL model 340. For example, suppose the experience 314 has a microservice with the highest probability of being used to execute the workload 305, but that is located a distance farther away from the workload 305 than the microservices of the other experiences. Given that the farther distance will likely cause a greater response time or system latency, the experience pruning module is able to determine that the experience 314 would generate a low reward as this experience is likely never to be selected by the RL model. In other words, the workload 305 will never be placed in the microservice defined by the experience 314 as this would increase response time. Thus, the experience 314 can be pruned from the list of experiences and need not be analyzed by the RL model 340, thus saving on time and computing system overhead.

The experience pruning module 330 generates a pruned list of experiences 332 that include those experiences that are likely to generate a high reward in the RL model 340. As shown, the pruned list of experiences 332 includes the experience 316 and any number of additional experiences as illustrated by the ellipse 334 that are determined to likely generate a high reward.

The pruned list of experiences 332 is then received by machine-learning model 340, which in the embodiment may be a RL model corresponding to the RL model discussed in relation to FIG. 1. As discussed, the RL model 340 will be trained using only the experiences included in the pruned list of experiences 332. Since the experiences likely to generate a low reward have been removed, the RL model 340 will more quickly converge to determining the to find the best workload-microservice association that is geographically closest to the workload 305 so as minimize system response time.

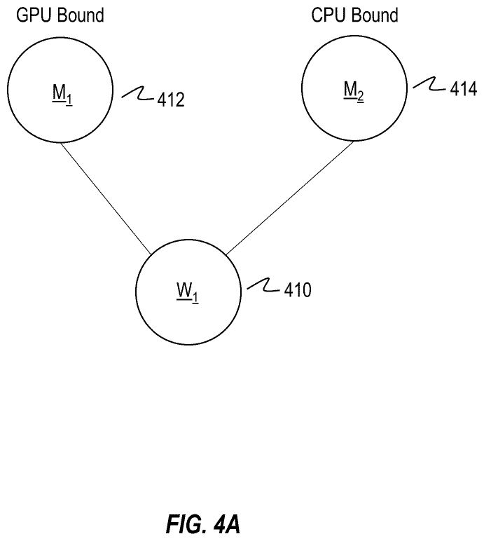

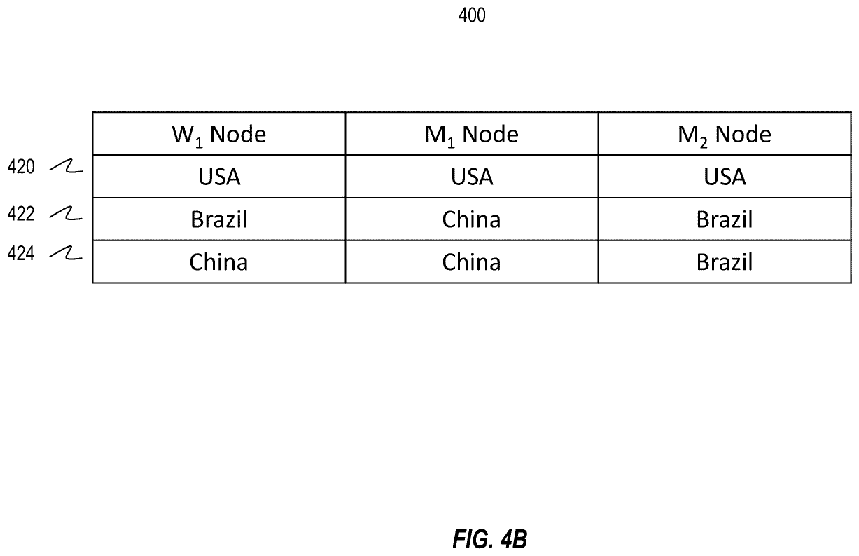

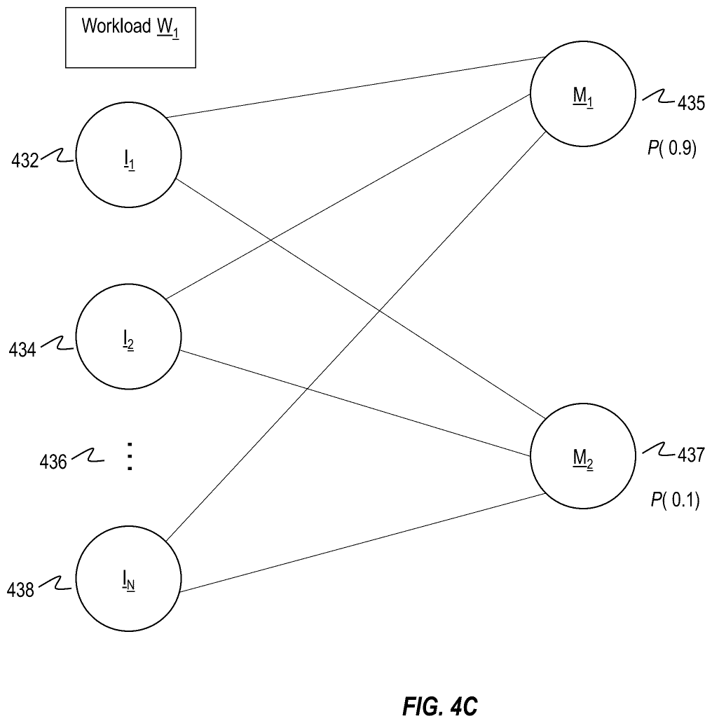

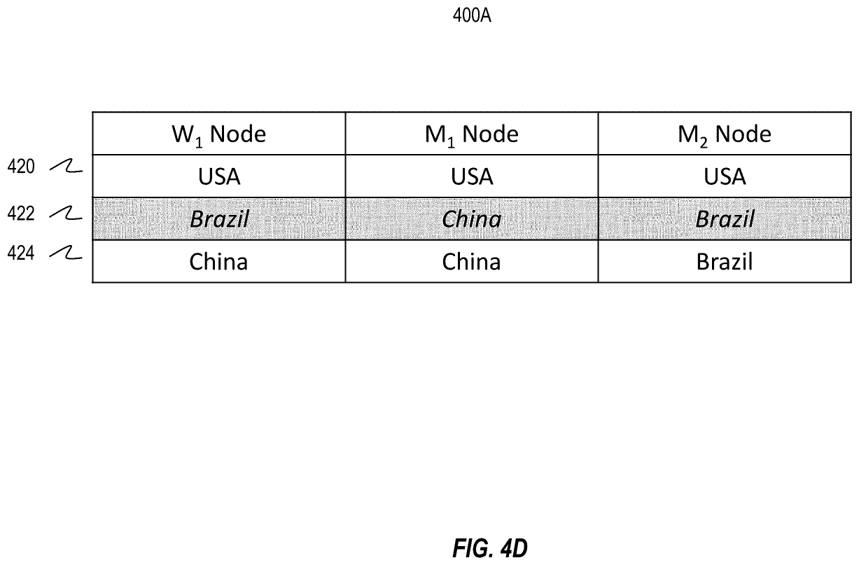

A specific use case of the computing system 300 will now be explained in relation to FIGS. 4A-4D. As shown in FIG. 4A, a workload W₁ shown at 410 is able to be executed by a microservice M₁ shown at 412 and a microservice M₂ shown at 414. The microservice M₁ is GPU bound, meaning that it will execute the data of workload W₁ using a GPU as part of its computing infrastructure and the microservice M₂ is CPU bound, meaning that it will execute the data of workload W₁ using a CPU as part of its computing infrastructure.

FIG. 4B illustrates an example list of defined experiences 400 that may correspond to the list of defined experiences 312 generated by the experience definition module 310. As shown in the list of defined experiences 400, a first defined experience 420 has the workload W₁, the microservice M₁, and the microservice M₂ placed in the USA. A second defined experience has the workload W₁ and the microservice M₂ placed in Brazil and the microservice M₁ placed in China. A third defined experience has the workload W₁ and the microservice M₁ placed in China and the microservice M₂ placed in Brazil.

FIG. 4C illustrates the action of the RBM model 320. As illustrated, each node of the visible layer represents features of the workload W₁ as inputs. As shown in FIG. 4C, the inputs includes an input I₁ shown at 432, an input I₂ shown at 434, and an input I_{N} shown at 438, with the ellipses 436 representing there can be any number of additional inputs. The nodes of the hidden layer represent the microservice M₁ shown at 435 and the microservice M₂ shown at 437. In operation, the RBM model 320 uses the inputs I₁, I₂, and I_{N} to estimate the probability P of the microservice M₁ and M₂, which may correspond to the probabilities 322 and 324. As illustrated, the probability P of the microservice M₁ is found to be 0.9 and the probability P of the microservice M₂ is found to be 0.1. Since the probability P of the microservice M₁ is found to be greater than the probability P of the microservice M₂, the workload W₁ is likely to be allocated to the microservice M₁.

FIG. 4D illustrates the action of the experience pruning module 330 in pruning one or more of the experiences from the list of defined experiences 400. Since the workload W₁ is likely to be allocated to the microservice M₁, the pruning module 330 analyzes the W₁ node and the M₁ node association to determine any experiences that should be pruned or removed. The experience 420 has the workload W₁ and the microservice M₁ both placed in the USA. Likewise, the experience 424 has the workload W₁ and the microservice M₁ both placed in China. In both experiences, the workload W₁ and the microservice M₁ are both placed at the same geographical location and so the response time or system latency is likely to be small and be within any SLA constraints. Thus, these experiences are likely to generate a good reward in the RL model and so are added to the pruned list of experiences 400A, which may correspond to the pruned list of experiences 332.

In contrast, the experience 422 has the workload W₁ placed in Brazil and the microservice M₁ placed in China. In this experience, the workload W₁ and the microservice M₁ are placed at greatly separated geographical locations and so the response time or system latency is likely to be large and outside of any SLA constraints. Thus, the experience 424 is likely to generate a bad reward in the RL model. That is, given that the experiences 420 and 424 will both result in better response times, the W₁ node and the M₁ node association of experience 422 will never be implemented. Accordingly, as shown by the highlights in FIG. 4D, the experience 422 is pruned from the pruned list of experiences 400A and thus will not be analyzed by the RL model 340, thus saving time and computing resource overhead as previously described since the RL model 340 will only analyze the experiences 420 and 424 included in the pruned list of experiences 400A. The pruned list of experiences 400A can then be provided to the RL model 340 for training as previously described.

### Example Methods

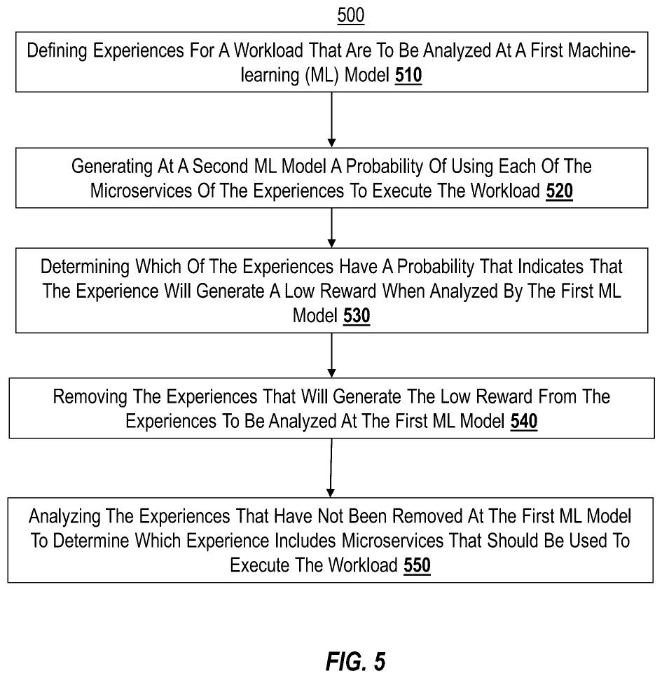

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 5, an example method 500 for one or more machine-learning models to remove experiences that will generate low rewards in an RL model. The method 500 will be described in relation to one or more of the figures previously described, although the method 500 is not limited to any particular embodiment.

The method 500 includes defining one or more experiences for a workload that are to be analyzed at a first machine-learning (ML) model, the one or more experiences defining an association between the workload and one or more microservices having computing resources configured to execute the workload (510). For example, as previously described the experience definition module 310 defines the experiences 312, 314, 316, and 318 in the list of experiences 312 for the workload 305 that are to be analyzed by the RL model 340. The experiences define the association between the workload 305 and the microservices M₁-M₄ and their computing resources 116.

The method 500 includes generating at a second ML model a probability of using each of the microservices of the one or more experiences to execute the workload (520). For example, as previously described the RBM model 320 generates the probabilities 322 and 324 for the experiences 314 and 316.

The method 500 includes determining which of the one or more experiences have a probability that indicates that the experience will generate a low reward when analyzed by the first ML model (530). For example, as previously described the experience pruning module 330 determines which experiences have a probability that indicates the experience will generate a low reward in the RL model 340.]

The method 500 includes removing the experiences that will generate the low reward from the one or more experiences to be analyzed at the first ML model (540). For example, as previously described the experience pruning module 330 removes the experience 314 from the pruned list of experiences 332 because the probability 322 indicates that the experience 314 will generate a low reward in the RL model 340.

The method 500 includes analyzing at the first ML model the one or more experiences that have not been removed to determine which experience includes one or more microservices that should be used to execute the workload (550). For example, as previously described the RL model analyzes the experiences in the pruned list of experiences 332 to determine which microservices should execute the workload 305 to reduce response time or system latency.

In general, embodiments of the invention may be implemented in connection with systems, software, and components, that individually and/or collectively implement, and/or cause the implementation of, placement operations including reward determination operations, reinforcement learning operations, workload migration operations, or the like. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general, however, the scope of the invention is not limited to any particular data backup platform or data storage environment. The workloads may include, for example, backup operations, deduplication operations, segmenting operations, fingerprint operations, or the like or combinations thereof.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### Further Example Embodiments

Following are some further example embodiments of the invention. These are presented only by way of example and are not intended to limit the scope of the invention in any way.

Embodiment 1. A method, comprising: defining one or more experiences for a workload that are to be analyzed at a first machine-learning (ML) model, the one or more experiences defining an association between the workload and one or more microservices having computing resources configured to execute the workload; generating at a second ML model a probability of using each of the microservices of the one or more experiences to execute the workload; determining which of the one or more experiences have a probability that indicates that the experience will generate a low reward when analyzed by the first ML model; removing the experiences that will generate the low reward from the one or more experiences to be analyzed at the first ML model; and analyzing the one or more experiences that have not been removed at the first ML model to determine which experience includes one or more microservices that should be used to execute the workload.

Embodiment 2. The method of embodiment 1, wherein the first ML model is a reinforcement learning (RL) model.

Embodiment 3. The method of any of embodiments 1-2, wherein the second ML model is a Restricted Boltzmann Machine (RBM) model.

Embodiment 4. The method of any of embodiments 1-3, wherein the first ML model determines which experience includes one or more microservices that should be used to execute the workload by performing the following: generating expected rewards including a first expected reward and a second expected reward; performing a first action on the workload, by an agent associated with the workload, when the first expected reward is higher than the second expected reward; and performing the second action on the workload when the second expected reward is higher than the first expected reward.

Embodiment 5. The method of embodiment 4, wherein the first action is to keep the workload at a current microservice and wherein the second action is to migrate the workload to a different microservice.

Embodiment 6. The method of embodiment 4, wherein the first ML model comprises a neural network configured to map to expected rewards.

Embodiment 7. The method of any of embodiments 1-6, wherein the one or more microservices that should be used to execute the workload are microservices placed at a geographical location that reduces response time or system latency when executing the workload.

Embodiment 8. The method of any of embodiments 1-7, wherein generating the probability comprises: providing one or more inputs into to the second ML model, the one or more inputs comprising one or more features of the workload; determining the computing resources associated with each of the one or more microservices; and using the inputs to determine the probability for each of the one or more microservices given the computing resources associated with each microservice.

Embodiment 9. The method of embodiment 8, wherein the one or more features include a data type of the workload, computing resources needed to execute the workload, a geographical location of the workload, and a usage or execution pattern of the workload.

Embodiment 10. The method of any of embodiments 1-9, wherein the computing resources include virtual machines, physical machines, GPUs, and CPUs configured to execute the workload

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### Example Computing Devices and Associated Media

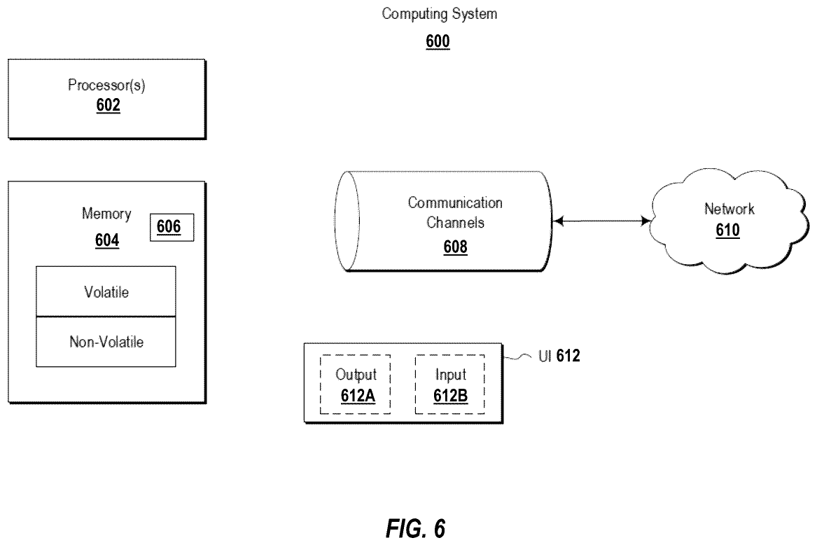

Finally, because the principles described herein may be performed in the context of a computing system some introductory discussion of a computing system will be described with respect to FIG. 6. Computing systems are now increasingly taking a wide variety of forms. Computing systems may, for example, be hand-held devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 6, in its most basic configuration, a computing system 600 typically includes at least one hardware processing unit 602 and memory 604. The processing unit 602 may include a general-purpose processor and may also include a field-programmable gate array (FPGA), an application-specific integrated circuit (ASIC), or any other specialized circuit. The memory 604 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 600 also has thereon multiple structures often referred to as an “executable component”. For instance, memory 604 of the computing system 600 is illustrated as including executable component 606. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, which are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent,” “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 604 of the computing system 600. Computing system 600 may also contain communication channels 608 that allow the computing system 600 to communicate with other computing systems over, for example, network 610.

While not all computing systems require a user interface, in some embodiments, the computing system 600 includes a user interface system 612 for use in interfacing with a user. The user interface system 612 may include output mechanisms 612A as well as input mechanisms 612B. The principles described herein are not limited to the precise output mechanisms 612A or input mechanisms 612B as such will depend on the nature of the device. However, output mechanisms 612A might include, for instance, speakers, displays, tactile output, holograms, and so forth. Examples of input mechanisms 612B might include, for instance, microphones, touchscreens, holograms, cameras, keyboards, mouse or other pointer input, sensors of any type, and so forth.

Embodiments described herein may comprise or utilize a special purpose or general-purpose computing system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hard-wired, wireless, or a combination of hard-wired or wireless) to a computing system, the computing system properly views the connection as a transmission medium. Transmission media can include a network and/or data links that can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively, or in addition, the computer-executable instructions may configure the computing system to perform a certain function or group of functions. The computer-executable instructions may be, for example, binaries or even instructions that undergo some translation (such as compilation) before direct execution by the processors, such as intermediate format instructions such as assembly language or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing systems which may correspond to the computing system 600 previously described. The computing systems of the remaining figures include various components or functional blocks that may implement the various embodiments disclosed herein, as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures, and some of the components may be combined as circumstances warrant. Although not necessarily illustrated, the various components of the computing systems may access and/or utilize a processor and memory, such as processing unit 602 and memory 604, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
defining one or more experiences for a workload that are to be analyzed at a first machine-learning (ML) model, the one or more experiences defining an association between the workload and one or more microservices having computing resources configured to execute the workload;
generating at a second ML model a probability of using each of the microservices of the one or more experiences to execute the workload;
determining which of the one or more experiences have a probability that indicates that the experience will generate a low reward when analyzed by the first ML model;
removing the experiences that will generate the low reward from the one or more experiences to be analyzed at the first ML model; and
analyzing the one or more experiences that have not been removed at the first ML model to determine which experience includes one or more microservices that should be used to execute the workload.

2. The method of claim 1, wherein the first ML model is a reinforcement learning (RL) model.

3. The method of claim 1, wherein the second ML model is a Restricted Boltzmann Machine (RBM) model.

4. The method of claim 1, wherein the first ML model determines which experience includes one or more microservices that should be used to execute the workload by performing the following:
generating expected rewards including a first expected reward and a second expected reward;
performing a first action on the workload, by an agent associated with the workload, when the first expected reward is higher than the second expected reward; and
performing the second action on the workload when the second expected reward is higher than the first expected reward.

5. The method of claim 4, wherein the first action is to keep the workload at a current microservice and wherein the second action is to migrate the workload to a different microservice.

6. The method of claim 4, wherein the first ML model comprises a neural network configured to map to expected rewards.

7. The method of claim 1, wherein the one or more microservices that should be used to execute the workload are microservices placed at a geographical location that reduces response time or system latency when executing the workload.

8. The method of claim 1, wherein generating the probability comprises:
providing one or more inputs into to the second ML model, the one or more inputs comprising one or more features of the workload;
determining the computing resources associated with each of the one or more microservices; and
using the inputs to determine the probability for each of the one or more microservices given the computing resources associated with each microservice.

9. The method of claim 8, wherein the one or more features include a data type of the workload, computing resources needed to execute the workload, a geographical location of the workload, and a usage or execution pattern of the workload.

10. The method of claim 1, wherein the computing resources include virtual machines, physical machines, GPUs, and CPUs configured to execute the workload.

11. A non-transitory storage medium having stored therein instructions that are executable by one or more hardware processors to perform operations comprising:
defining one or more experiences for a workload that are to be analyzed at a first machine-learning (ML) model, the one or more experiences defining an association between the workload and one or more microservices having computing resources configured to execute the workload;
generating at a second ML model a probability of using each of the microservices of the one or more experiences to execute the workload;
determining which of the one or more experiences have a probability that indicates that the experience will generate a low reward when analyzed by the first ML model;
removing the experiences that will generate the low reward from the one or more experiences to be analyzed at the first ML model; and
analyzing the one or more experiences that have not been removed at the first ML model to determine which experience includes one or more microservices that should be used to execute the workload.

12. The non-transitory storage medium of claim 11, wherein the first ML model is a reinforcement learning (RL) model.

13. The non-transitory storage medium of claim 11, wherein the second ML model is a Restricted Boltzmann Machine (RBM) model.

14. The non-transitory storage medium of claim 11, wherein the first ML model determines which experience includes one or more microservices that should be used to execute the workload by performing the following:
generating expected rewards including a first expected reward and a second expected reward;
performing a first action on the workload, by an agent associated with the workload, when the first expected reward is higher than the second expected reward; and
performing the second action on the workload when the second expected reward is higher than the first expected reward.

15. The non-transitory storage medium of claim 14, wherein the first action is to keep the workload at a current microservice and wherein the second action is to migrate the workload to a different microservice.

16. The non-transitory storage medium of claim 14, wherein the first ML model comprises a neural network configured to map to expected rewards.

17. The non-transitory storage medium of claim 11, wherein the one or more microservices that should be used to execute the workload are microservices placed at a geographical location that reduces response time or system latency when executing the workload.

18. The non-transitory storage medium of claim 11, wherein generating the probability comprises:
providing one or more inputs into to the second ML model, the one or more inputs comprising one or more features of the workload;
determining the computing resources associated with each of the one or more microservices; and
using the inputs to determine the probability for each of the one or more microservices given the computing resources associated with each microservice.

19. The non-transitory storage medium of claim 18, wherein the one or more features include a data type of the workload, computing resources needed to execute the workload, a geographical location of the workload, and a usage or execution pattern of the workload.

20. The non-transitory storage medium of claim 11, wherein the computing resources include virtual machines, physical machines, GPUs, and CPUs configured to execute the workload.
